(19) United States
(12) Patent Application Publication
(10) Pub. No.: US 2006/0005711 A1
(43) Pub. Date: Jan. 12, 2006

(54) Replaceable filter for a vehicle air conditioning system adapted to scent air

(76) Inventor: Andrew Olefson, Fort Lauderdale, FL (US)

Correspondence Address: GIFFORD, KRASS, GROH, SPRINKLE & CITKOWSKI, P.C, PO BOX 7021, TROY, MI, 48007-7021, US

(21) Appl. No.: 11/176,539

(22) Filed: Jul. 7, 2005

Related U.S. Application Data
(60) Provisional application No. 60/586,052, filed on Jul. 7, 2004.

(51) Int. Cl. B01D 46/00

(52) U.S. Cl. 96/222

(57) ABSTRACT

A replaceable air filter for a vehicle air conditioning system employs a pleated, porous filter media coated with a perfume polymer composition to impart a long-lasting scent to air passing through the filter. In alternative embodiments of the invention the perfume/polymer composition is contained in a sheet overlying the filter material, in the frame or in a bead supported by the filter.

### RELATED APPLICATION

This application claims priority of U.S. Provisional Patent Application Ser. No. 60/586,052 filed Jul. 7, 2004, which is incorporated herein by reference.

### FIELD OF THE INVENTION

This invention relates to air conditioning systems for automotive vehicles, such as passenger cars or trucks, including replaceable filters for the air passing through the system, and more particularly, to such a filter which is formed with materials which will emit scents into the passing air during the life of the filter.

### BACKGROUND OF THE INVENTION

Most modern vehicles incorporate an air conditioning system which draws incoming air either from the vehicle cabin or from the air external to the vehicle, or some combination of the two, and either heats or cools the air, or simply filters the air before reintroducing it into the vehicle cabin. The filter acts to remove particulate matter, odors from outside of the vehicle, and the like, and after long use tends to become clogged with material removed from the air stream, increasing its resistance to air passage so that it requires replacement.

A number of patents disclose systems incorporating replaceable air filters for such systems, including U.S. Pat. Nos. 5,062,353 and 6,623,350. The filter supports are located at positions which simplify the filter replacement, such as in the passenger cabin, or in the forward side of the cowl of the vehicle under the hood.

Separately, a wide variety of devices are marketed for scenting the air within the vehicle cabin by releasing a perfume, or the like. A variety of patents disclosing devices of this type are classified in Class 422/005. Essentially, they constitute structures which may be suspended in the vehicle cabin, for example, in front of the exit vent of the air conditioning system, which are impregnated with scents so as to impart the scents to air within the cabin. These devices must be replaced at frequent intervals and are often sold in auto wash establishments and the like. By contrast, the filters of air conditioning systems are replaced at relatively infrequent intervals and short-lived scenting arrangements would quickly be depleted.

It has been proposed to use the replaceable cabin air filter of the air conditioning system to impart scent. For example, U.S. published application Serial No. 2002/013921 suggests incorporating scents in decorative trimming attached to the outside frame of the filter. Also, U.S. Pat. No. 6,080,059 states, “ . . . in some applications, it will be desirable to include an aromatic substance, which would provide an air-freshening effect appealing to some users, such as flower scent, pine scent, lemon scent, or other pleasant scents.” The patent is otherwise silent as to the matter of incorporation of this scent.

The prior art does not address the problem of providing a replaceable air filter, which is typically replaced at long intervals, with a scent-producing mechanism that will be operative for the life of the filter.

### SUMMARY OF THE INVENTION

The present invention is accordingly directed to a replaceable cabin air filter for a vehicle air conditioning system which may be part of the original vehicle or an aftermarket replacement in which either the filtering media or the frame used to support the media, or sections adhered to the media or the frame, are formed of materials which are scented and release their scent over a long period of time, or are impregnated with a long-lasting scent.

Essentially, the present invention comprises a cabin air filter wherein the filter material, or the framing for the filter material, or adhesives used to secure the filter material within the framing material, or a bag or sheath for an otherwise unscented filter, are formed of compositions incorporating a perfume within a polymer composition so that as air flows through the filter, it will be impregnated with the odor and the odor-releasing action will extend at least until, and preferably beyond, the normal useful life of the filter, which is limited by clogging. Alternatively, the scent may be sprayed on the filter before installation.

A variety of odorant-polymer compositions are known to the art and operate to provide the odorant to flowing air over a much longer lifetime than would be achieved by spraying a solid material with a perfume, as has been suggested by the art noted above. Such compositions may include a polymer-perfume composition as disclosed in U.S. Pat. No. 3,994,439; the coating composition of an essential oil fragrance with a polyurethane latex as disclosed in U.S. Pat. No. 4,950,542; the sustained release aromatic composed of a clathrate compound of a perfume and a polyphenyl compound as disclosed in U.S. Pat. No. 4,880,774; or any variety of similar compounds.

The filter material itself is preferably pleated to achieve a relatively wide surface area relative to the cross-section of the airflow path. The filtering media may take the form of a paper which includes one of the perfume-polymer compositions noted above. The composition may be formed as part of the paper, or may be coated on the paper after formation. Alternatively, the polymer-odorant composition may be incorporated in a porous sheet which is layered over the pleated filter media. Preferably, the porous sheet has a larger than average pore size than the porous media so that the particulate matter captured by the filter will be retained on the filter media itself. Alternatively, the polymer-fragrance composition may be molded into the plastic frame for supporting the filter media, which may be pleated or unpleated. This may be performed during the molding process for the frame, or the already molded frame may be coated with the odorant-polymer composition.

In still another embodiment of the invention, the odorant-polymer composition may form part of a bead or strip adhered to the pleated tip of the filter media.

### BRIEF DESCRIPTION OF THE DRAWINGS

Objectives, advantages and applications of the present invention will be made apparent by the following detailed description of preferred embodiments of the invention. The description makes reference to the accompanying drawings in which:

FIG. 1 is a schematic diagram illustrating the relationship of the air filter of the present invention with the air intake and the vehicle cabin;

FIG. 2 is a perspective view of the dashboard area of an automobile incorporating a filter with a replaceable media, partially broken away for purposes of illustration;

FIG. 3 is a perspective view of a pleated air filter formed in accordance with the present invention, partially broken away for purposes of illustration;

FIG. 4A is a cross-sectional view through one of the filter pleats taken along lines 4-4 of FIG. 3; and

FIG. 4B is a cross-sectional view through an alternative form of pleated filter.

### DETAILED DESCRIPTION OF THE INVENTION

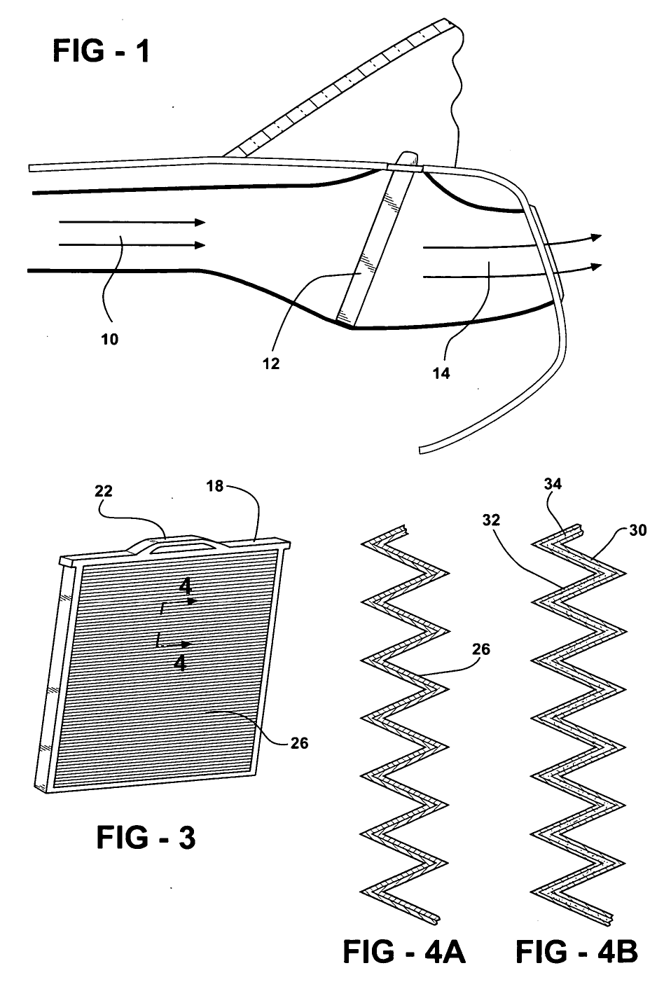

The environment of the system of the present invention is broadly illustrated in the schematic of FIG. 1. The system operates from the source of incoming air 10 to the vehicle HVAC system, which may be air withdrawn from the vehicle cabin or air from the exterior of the vehicle, or some combination of both. Typically, the operator controls on the dashboard of the vehicle associated with the vehicle air conditioning system allow control of the composition of the incoming air. The incoming air is forced through a cabin air filter of a conventional construction, except for the nature of the perfume or odorant employed with the filter media or the filter frame, generally indicated at 12, by a conventional fan (not shown) typically deployed in the engine compartment. Air passing through the filter, and imparted with a perfume in accordance with the present invention, is passed to the passenger cabin of the vehicle through an exit vent 14.

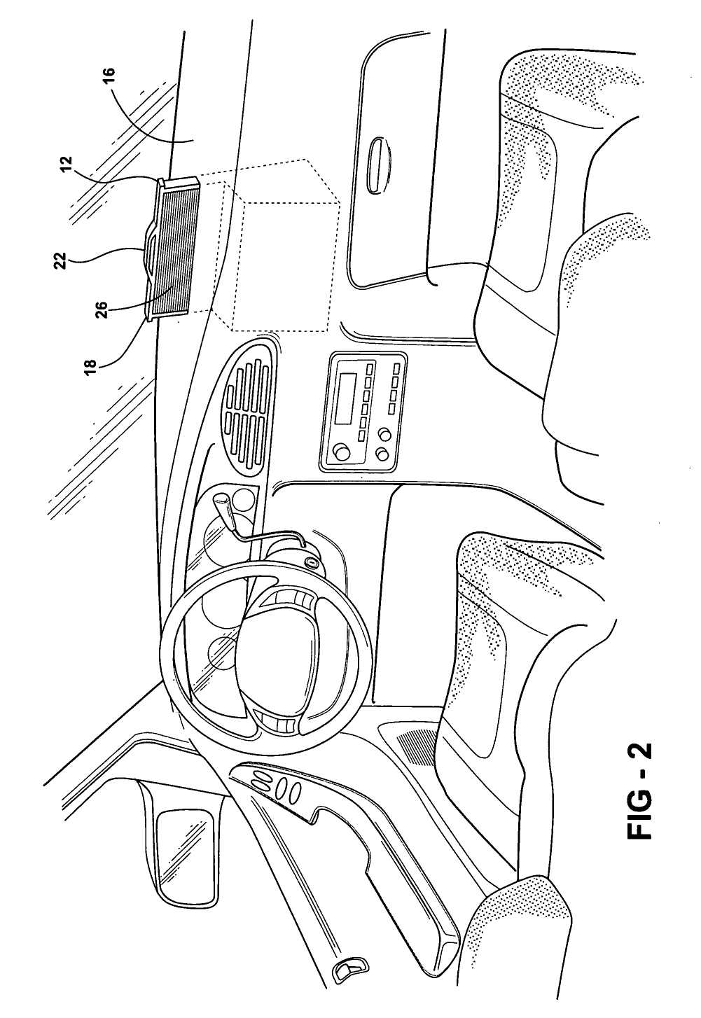

The air filter may be located so as to be accessible under the hood of the vehicle or within the cabin. FIG. 2 illustrates a perspective view from the cabin of the vehicle, partially broken away, incorporating air filter 12 which may be removed through the top of the dashboard 16 of the vehicle. The removable replaceable filter element 12 comprises a rectangular frame 18 supporting a pleated filter member 26. A handle 22 at one end of the frame 18 allows the filter member to be removed and inserted from an appropriate supporting structure for replacement purposes. Allowing replacement from a readily accessible location in the vehicle encourages the replacement of the filter element as needed.

FIG. 3 illustrates a replaceable filter formed in accordance with the present invention. The media is formed in a rectangular frame 18 preferably formed of a plastic material such as polystyrene or polyethylene. The frame retains a filter media 26 which is formed with a number of pleats across its width. Air forced into the filter media by the system fan encounters the full pleated surface which is substantially greater than the rectangular area within the frame 18, thus increasing the surface area of the filter.

The material from which the pleated filter elements 26 is formed constitutes a porous sheet material which is preferably a paper but may be a carbon-based material, a foamed plastic or the like. The material is typically manufactured in large rolls so that it may be cut and pleated to fit particular applications.

In a preferred embodiment of the present invention this filter media is impregnated with a composition incorporating a perfume dispersed within a polymer. In a preferred embodiment of the invention this composition is applied to the filter paper while it is in roll form by dipping the paper in an air-drying solution of the composition or spraying the scented solution on the media. After being applied, the composition is preferably calendered by rollers, surface blades or the like to form a very thin coating which does not block the pores of the filter material. In one preferred embodiment of the invention, the coating material comprises a clathrate compound consisting of a perfume and a polyphenyl.

The perfume used in the coating composition may be any one of a wide variety of commercially available perfumes typically each involving a proprietary composition. These are typically available in liquid form. The perfume is typically chosen based on its odor and may consist of a mixture of two or more kinds of perfume. Lemon, cinnamon, jasmine, rose, lavender and spearmint are among the popular fragrances commercially available.

The polyphenyl may be selected from a wide range of carboxylic compounds having two or more benzene nuclei. Typically a powder of the polyphenyl compound is added directly to liquid or molten perfume and thoroughly mixed. Alternatively, a coating composition consisting of a perfume with a polyurethane latex as disclosed in U.S. Pat. No. 4,950,542 may be employed or any of a variety of similar long-lasting fragrances.

In addition to coating the odorant composition onto a porous filter media, it can be incorporated in a separate thin sheet which is then pleated with a basic filter media and cut for application. It is important that the pore size of the scented media paper is equal to or greater than the pore size of the basic filter media to prevent premature clogging of the filter.

In still another alternative embodiment of the invention, the composition of the perfume or odorant in a polymer carrier may be applied to the frame 18 or to a glue bead or strip adhered to the pleated media.

FIG. 4A represents a cross section, taken along line 4-4 of FIG. 3, of one of the pleats of the filter 26 wherein the filter media is saturated with the perfume in its polymer carrier so as to impart a long-lasting scent into the filter.

In the alternative cross-section shown in FIG. 4B, the scented material may be formed as a powder 30 or small beads sandwiched between two sheets of filter media 32 and 34. This structure allows a larger volume of the polymer-perfume material to be incorporated into the filter and provides an unusually long-lasting filter.

Having thus described my invention I claim:

1. A removable air filter for an air conditioning system for the cabin of a vehicle, comprising:
a filter media, including a composition incorporating an odorant in a polymer carrier so as to impart scent to the air passing through the filter media for the entire life of the filter.

2. The air filter of claim 1 wherein the odorant-polymer composition is formed in a frame for the filter media.

3. The air filter of claim 1 wherein the odorant-polymer composition is formed of a material adhered to the filter media.

4. The air filter of claim 1 wherein the odorant comprises a commercially available perfume.

5. The air filter of claim 3 wherein the odorant-polymer composition is adhered to the filter media by dipping the filter media into a solution of the odorant-polymer.

6. The air filter of claim 1 wherein the odorant-polymer composition is adhered to the filter media by spraying a solution of the odorant-polymer composition onto the filter media.

7. The air filter of claim 1 in which the air filter is removable through the instrument panel of the vehicle.

8. The air filter of claim 1 in which the filter is removable under the engine hood of the vehicle.

9. The air filter of claim 1 in which the polymer is a phenol compound.

10. The air filter of claim 1 in which the polymer is an ethylene compound.

11. The air filter of claim 1 in which the polymer is a urethane compound.

12. A replaceable filter for vehicle air conditioning systems adapted to scent air passing through the system, comprising:
a rectangular plastic frame; and
a pleated filter media retained within the frame, the filter media being impregnated with a composition of an odorant in a polymer carrier.

13. The replaceable filter of claim 12 wherein the coating material is a clathrate compound of a perfume in a polyphenyl compound.

14. The replaceable filter of claim 12 in which the polymer is chosen from the group consisting of ethylene, phenol and urethane.
